(19) United States
(12) Patent Application Publication
(10) Pub. No.: US 2022/0054993 A1
(43) Pub. Date: Feb. 24, 2022

(54) MIXING DEVICE

(71) Applicant: GenMark Diagnostics, Inc., Carlsbad, CA (US)

(72) Inventor: Mohammad Sotoudeh, Carlsbad, CA (US)

(73) Assignee: GenMark Diagnostics, Inc.

(21) Appl. No.: 16/997,845

(22) Filed: Aug. 19, 2020

(51) Int. Cl. B01F 7/00; B01F 7/16; B01F 15/00; B01F 3/08

(52) U.S. Cl. CPC B01F 7/00708; B01F 7/007; B01F 7/1625; B01F 15/00915; B01F 2215/0037; B01F 7/00591; B01F 3/0853; B01F 2215/0422; B01F 2215/0073; B01F 15/0098

(57) ABSTRACT

A device for the mixing fluid media. The device is a bladeless mixer. The device comprises a hollow body with at least a single inlet opening in its bottom and at least a single outflow region in its side. The device is rotated at a speed at which the media due to centrifugal forces enters the device's hollow cavity via the inflow opening or unit. The media is discharged from the cavity through one or more outlet units or openings in the sides or in the top of the device. During mixing the media does not rise above the level of the undisturbed media.

### TECHNICAL FIELD

The present invention is directed generally to mixing devices and more particularly to bladeless mixing devices.

### BACKGROUND

Preventable medical errors are now the third leading cause of death in the United States at more than 250,000 per year. Some rapid molecular diagnostic systems, like GenMark's e-Plex system, are designed to reduce medical error. Yet, no matter how well a diagnostic system is designed, if the consumable product is not manufactured correctly, preventable medical errors can arise. Further, when manufactured lots do not pass quality control they must be scrapped causing supply chain issues. Consistently supplying laboratories and hospitals with cartridges for processing patient samples is difficult because of their short shelf-life and the seasonable demand for some tests. For example, during the unprecedented Corona Vials pandemic of 2019-2020, many hospitals/laboratories were at critically-low levels of rapid molecular respiratory cartridges.

The lack of supply can lead to serious problems for a patient whose sample must be analyzed rapidly. In some cases, such a lack of supply can be deadly, such as for sample processing cartridges which detect organisms that cause sepsis. Recent studies have shown that patients with severe sepsis or septic shock showed a 7.6% increased likelihood of death for every hour in which antibiotic therapy is not applied. Liang et al., Empiric Antimicrobial Therapy in Severe Sepsis and Septic Shock: Optimizing Pathogen Clearance, Curr Infect Dis Rep. 2015 July; 17(7): 493.

### BRIEF SUMMARY

A device for mixing is disclosed. The device comprises a body, which is at least partially hollow, and is driven by a driving unit. The body comprises at least one inflow region, at least one outflow region and a cavity. In operation, the body is partly immersed in medium, the medium is drawn into the body through the openings 6, 7 of the body 1. The medium raises within the body's cavity 4 due to centrifugal forces created by medium inside the outflow regions 7 and is dissipated through outflow regions 7 back into the container 13. The mixing device and method results in low turbulence and shear force on the molecules and/or particles being mixed.

### BRIEF DESCRIPTION OF THE DRAWINGS

The mixing device may be better understood with reference to the following drawings and description. The components in the figures are not necessarily to scale. Moreover, in the figures, like-referenced numerals designate corresponding parts throughout the different views.

FIG. 1 depicts the typical configuration of a conventional stirred tank. Typically, an impeller is attached to a stir shaft.

FIG. 2 illustrates the flow pattern in tanks using impellers.

FIG. 3 illustrates the flow pattern in tanks using radial flow impellers.

FIG. 4 shows a longitudinal section of an embodiment of a new mixing body, designated generally as “1,” in elevation within a mixing container 13.

FIGS. 5A-5C show the location of material before the mixing body is activated (FIG. 5A), the liquid level is at height A and the sediment is at height B; just after (about 2 seconds) the mixing body is activated (FIG. 5B), the liquid level is at height A and the sediment is at height B; and when the material has been mixed by the mixing body (FIG. 5C) (about 3 seconds) A and B are the same because the liquid and sediment are mixed.

FIG. 6A is a side elevation view of a portion of the mixing body with one central inflow region.

FIG. 6B is a side elevation view of a portion of the mixing body with a number of inflow regions.

FIG. 6C is an end view of a portion of the mixing body with an inflow region shaped like a circle.

FIG. 6D is an end view of a portion of the mixing body with an inflow region shaped like a square.

FIG. 6E is an end view of a portion of the mixing body with an inflow region shaped like a triangle.

FIG. 6F shows a side elevation view of a portion of an inflow region at starts narrower at the outer body and expands towards the inner body

FIG. 6G shows a side elevation view of a portion of an inflow region that starts broader at the outer body and narrows towards the inner body.

FIG. 6H shows a side elevation view of a portion of an inflow region with a. filter.

FIG. 7A is an elevation view that shows an outflow region having a single circular opening.

FIG. 7B is an elevation view that shows an outflow region having multiple circular openings.

FIG. 7C is a schematic section view in elevation of the body showing outflow regions that are disposed evenly (i.e. at the same height) across the wail of the body.

7D is a schematic section view in elevation of the body showing outflow regions that are disposed unevenly (i.e. at different heights) across the wall of the body.

FIG. 7E is a schematic section view in elevation of the body showing outflow regions are disposed unevenly across only one wall of the body.

FIG. 7F is an elevation view that shows an outflow region having an oval opening.

FIG. 7G is an elevation view that shows an outflow region shaped like a rectangle (e.g., a square).

FIG. 7H is an elevation view that shows an outflow region shaped like a triangle.

FIG. 7I is a schematic plan view that shows a portion of the outflow region with a variable diameter, i.e., the outflow region has a smaller opening at an outer surface of the body that increases in size until it ends at an inner surface of the body.

FIG. 7J is a schematic plan view that shows a portion of the outflow region with a variable diameter, i.e., the outflow region has a larger opening at the outer surface of the body that decreases in size until it ends at the inner surface of the body.

FIG. 8A is a schematic drawing that shows how the device can be used to cause rotation. Fluid in a first container (C1), which is stationary, flows into the body at a first velocity (V1) and flows out the outflow regions at a second velocity (V2). V2 causes the second container (C2) to rotate relative to the first container C1.

FIG. 8B is a schematic drawing similar to FIG. 8A, but showing how the device can be used to cause dampening of rotation.

FIG. 9A shows a perspective view of an embodiment of the mixing body.

FIG. 9B shows a transparent perspective view of the mixing body of FIG. 9A to illustrate internal structure.

FIG. 9C shows a front elevation view of the mixing body of FIG. 9B.

FIG. 9D shows a cross section taken along lines 9D-9D from FIG. 9C

FIG. 9E shows a cross section taken along lines 9E-9E from FIG. 9C.

FIG. 9F shows a cross section taken along lines 9F-9F from FIG. 9C.

FIG. 10 shows a longitudinal section of the mixing body of FIG. 9B.

FIG. 11 shows an embodiment of the mixing body cut in half and the direction of media flow.

FIG. 12 is another perspective view showing the mixing both of FIG. 9A, which is also described as a mixing body with a top.

FIG. 13 shows an embodiment of the mixing body of FIG. 12 without a top.

FIG. 14 shows an embodiment of the mixing body with a lower body 19 and a middle body 20, i.e, without a top.

FIG. 15 shows an embodiment of the mixing, body with a lower body 19 and without a top.

FIG. 16 shows a front and top perspective view of the mixing body of FIGS. 9A and 12.

FIG. 17 shows a left side elevation view of the mixing body of FIG. 16.

FIG. 18 shows a right-side elevation view of the mixing body of FIG. 16.

FIG. 19 shows a front elevation view of the mixing body of FIG. 16.

FIG. 20 shows a rear elevation view of the mixing body of FIG. 16.

FIG. 21 shows a top plan view of the mixing body of FIG. 16.

FIG. 22 shows a bottom plan view of the mixing body of FIG. 16.

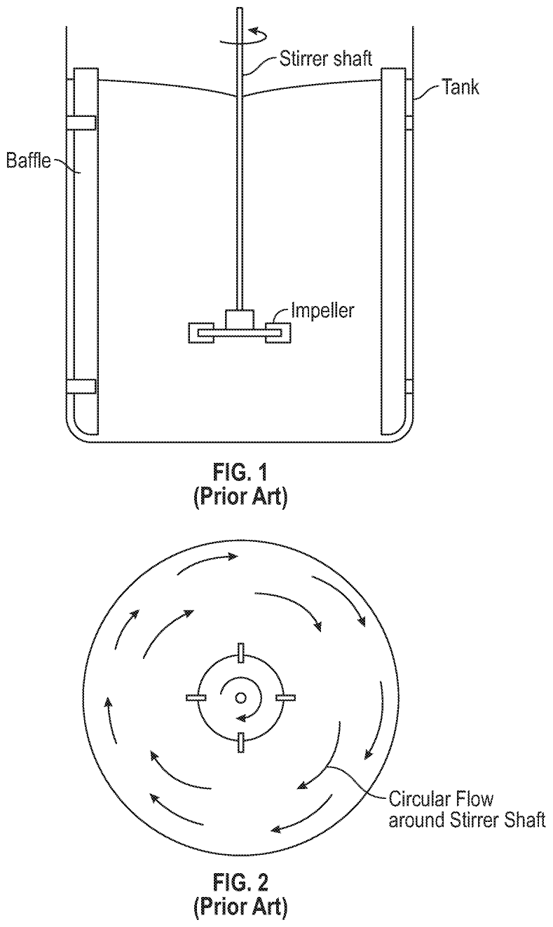

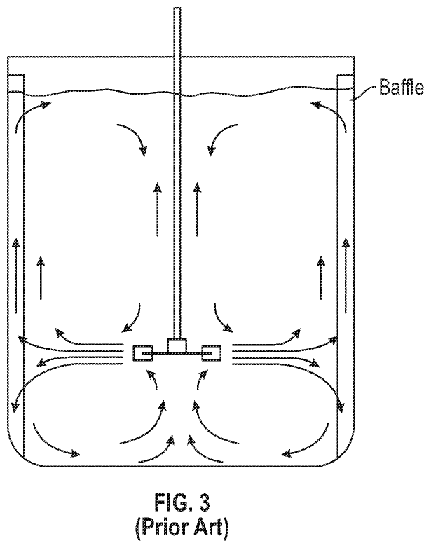

### DETAILED .DESCRIPTION

### BACKGROUND

Mixing involves manipulating a heterogeneous system to obtain a more homogenous system. The mixing process exerts a certain amount of shear force on the matter being mixed which can damage the matter.

Equipment used for mixing is referred to as mixers. The mixers differ in their construction based on the desired output and the limitations to be adhered to in obtaining the output. A mixer can generally disperse one phase (liquid, solid, gas) into a more continuous phase (liquid, solid, gas).

Methods used for mixing liquid volumes include stirring with paddles, rotating impellers, blades, magnetic bars or rocking, rolling, or vortexing the entire vessel. All these methods produce symmetric agitation dynamics and have incomplete mixing. Symmetric mixing patterns do not include the overall volume of the container and do not provide efficient or complete mixing regardless of the length of mixing time. There are multiple concentration layers, which indicate that these methods cannot reach a uniform state.

Turbulence and chaotic agitation dynamics have been shown to enhance mixing. Turbulent elements disrupt these patterns and enhance the impact and exposure of the mixed components. Baffles attached to the wall of the container or suspended in the container to interrupt regular mixing patterns and can be used to improve mixing. Variable pitch impellers and stir bars can also be used to improve mixing. But these approaches have limited effectiveness for liquid areas that are not close in proximity to the baffle, impeller or stir bar. Rocking or rolling the vessel can also be used to improve mixing but has limited effectives.

### Rotors and Impellers

A rotor or impeller, together with a stationary component known as a stator, is used either in a tank containing the solution to be mixed, or in a pipe through which the solution passes. The use of impeller or rotor creates shear force and thus acts as an enabler for homogenization of two dissimilar materials. For example, a high-shear mixer can be used to create emulsions, suspensions, lyosols (gas dispersed in liquid), and granular products. A rotor or impeller can only change speed, geometry, or agitation time, and has limited effects in the liquid region not near the agitation bar or impeller.

### Stirrers

Alternatively, a mixer can be provided with a stirrer connected to a motor to drive the stirrer for agitating the substances at required speeds. The stirrer could comprise a plurality of blades and is rotated in clockwise or anti clockwise direction using the motor for mixing liquid or solids. In conventional methods, the liquids of different densities are mixed by moving the liquids from top to bottom and vice versa. Thus, the pattern of mixing the liquids is limited to only one pattern due to stirrer possessing only one degree of motion. In order to obtain uniform mixing, vigorous agitation is induced through high speed stirrers which will cause high turbulence and thus higher velocity of moving particles and shear force on the molecules.

### Vortex Mixer

Various forms of mixers are also used in the biological lab and biotechnology industries, including, e.g., vortex mixers. Vortex mixers consist of an electric motor with the drive shaft oriented vertically and attached to a cupped rubber piece mounted slightly off-center. As the motor runs the rubber piece oscillates rapidly in a circular motion. When a test tube or other appropriate container is pressed into the rubber cup and the motion is transmitted to the liquid inside and a vortex is created.

### Magnetic Stirrer

A magnetic stirrer or magnetic mixer is another example of a laboratory device that employs a rotating magnetic field to cause a stir bar immersed in a liquid to spin very quickly, thus stirring it. The rotating field may be created either by a rotating magnet or a set of stationary electromagnets, placed beneath the vessel with the liquid. Magnetic stirrers often include a hot plate or some other means for heating the liquid. Other such examples include homogenizers, orbital shakers, etc. These methods rely on high stirrer speeds to improve mixing in areas away from the stirrer, stir bar or impeller. This can change the liquid or sample cells or other fragile components, which can be energized or physically compromised. This is particularly problematic when stirring living organisms such as plant or animal cells, bacterial or viral specimens and proteins, unstable molecules or long chain chemicals.

### High or Low Speed Agitators

There exist primarily two types of mixing devices, those with high or low speed agitators. High speed agitators are utilized for low viscous media and produce good dispersion. However, they cannot be used with liquids of high viscosity. Low speed agitators can be used for liquids of high viscosity, for instance, anchor agitators, band, comb agitators and the like. None of them, however, secures a perfect dispersion due to the slow stirring.

### Vertical Agitation

Vertical agitation is achieved by the use of an agitation bar with a permanent magnet and having a length greater than the inner diameter of a small container. The length of the stirring bar is positioned almost vertically in the container. In high volume applications, the stir bar is floating due to its vertical position. By inducing the motion of the agitation bar with multiple magnetic fields to generate various agitation patterns and selectable multi-dimensional motion, gentle and efficient mixing occurs throughout the vessel. When the stir bar is moved in a regular and irregular pattern during low speed agitation operations, the chaotic material motion and turbulence required to achieve complete mixing throughout the liquid is generated.

### Rocking and Rolling

Rocking, or rolling moves the liquid all at once, limiting the material interaction and limiting the mixing at corners, along the walls of the container, near or at the top of the liquid meniscus.

Challenges with Mixing

Incomplete mixing causes problems because no homogeneity in the sample is obtained. This causes downstream processing errors due to sampling or drawing in the enriched layer or between layers. As a result, random changes in process operation occur, resulting in variations and waste in the manufactured product.

Small volumes (under 100 microliters) require more complete and controlled mixing to produce accurate and reproducible results or maximum production without destroying the ingredients or artificially changing them.

Issues with mixing include regions that are partially mixed or unmixed, resulting in a concentration related stratification in the reactants. Furthermore, it is known that efficient mixing can only be activated if the flow pattern is interrupted or changed randomly.

### Damage Caused by Mixing

Current mixers produce high velocity, turbulence, shear stress and frothing. All these factors can be damaging to chemical/biochemical/biological components and are therefore undesirable in biotechnology and biomedical industries. For example, several biochemical components such as proteins can get oxidized or denatured by frothing. Turbulence can be especially disadvantageous while mixing living biological samples such as cells and tissues which can be damaged by the effects of shear force. Currently shear and turbulence effects can be reduced by using exogenous additives such as a mild surfactant. In biological samples, use of such additives can be toxic and undesirable.

There is a need for an efficient and gentle mixing technique that produces a liquid that is efficiently mixed in a container by generating an asymmetric mixing pattern that includes the total volume of the container without changing the components.

The present invention generates mild chaotic agitation mechanics to affect the total volume of liquid in the container while reducing the time to reach homogeneity without introducing very large mechanical forces on the material being mixed. In comparison to the prior art, the disclosed mixer allows for the complete mixing of the small particles in the fluid (not achieved by rotary and shaker mixers) without damaging them (e.g., by propeller mixers and sonication systems) during the mixing process.

### Overview

As mentioned above, consistently supplying laboratories and hospitals with cartridges for processing patient samples is difficult because of their complex manufacture. Failure to properly manufacture cartridges can lead to serious problems for a patient whose sample must be analyzed rapidly. One way in which to ensure proper manufacturing is to ensure that reagents are mixed properly before they are loaded into/onto the cartridge.

### Definitions

As used herein, the following terms have the meanings ascribed to them unless specified otherwise.

Mixing: a physical process which aims at reducing non-uniformities in media by eliminating gradients of concentration, temperature, and other properties.

### Mixing Device

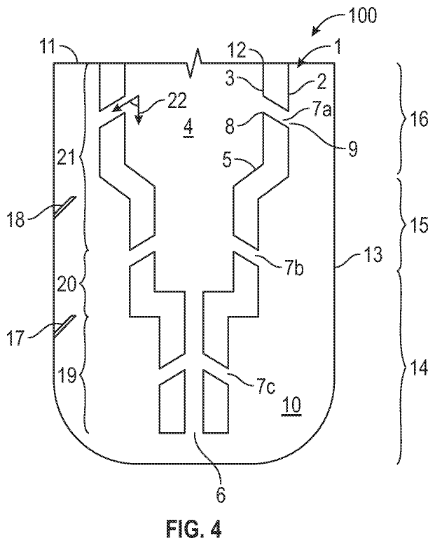

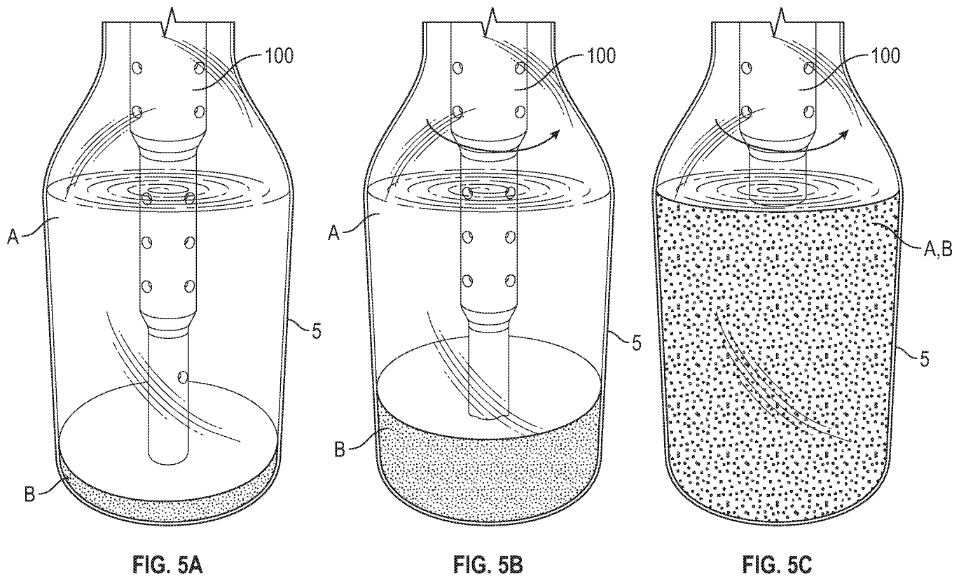

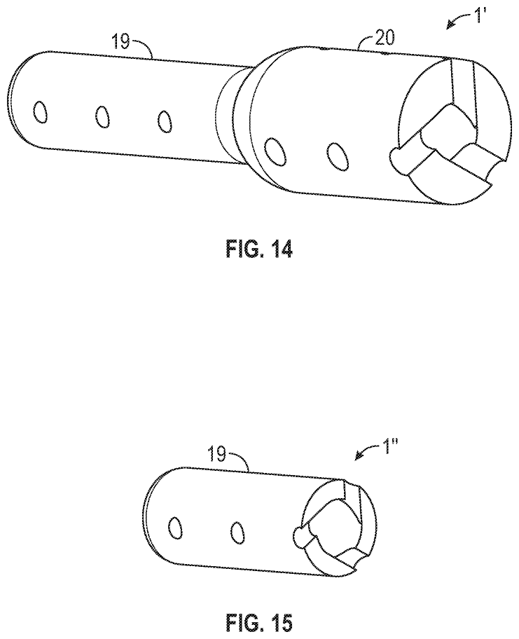

According to one representative embodiment as shown, a mixing system 100 has a rotor or body 1, a longitudinal section thereof being shown in FIG. 4 within a vessel or mixing container 13. The body 1, has a lower body 19, a middle body 20 and an upper body 21. The body 1 can be positioned in the center of the mixing chamber or off center. In some embodiments, a body 1′ has just a lower body 19 and a middle body 20 (see, e.g., FIG. 14). In some embodiments, a body 1″ has just a lower body 19 (see, e.g., FIG. 15).

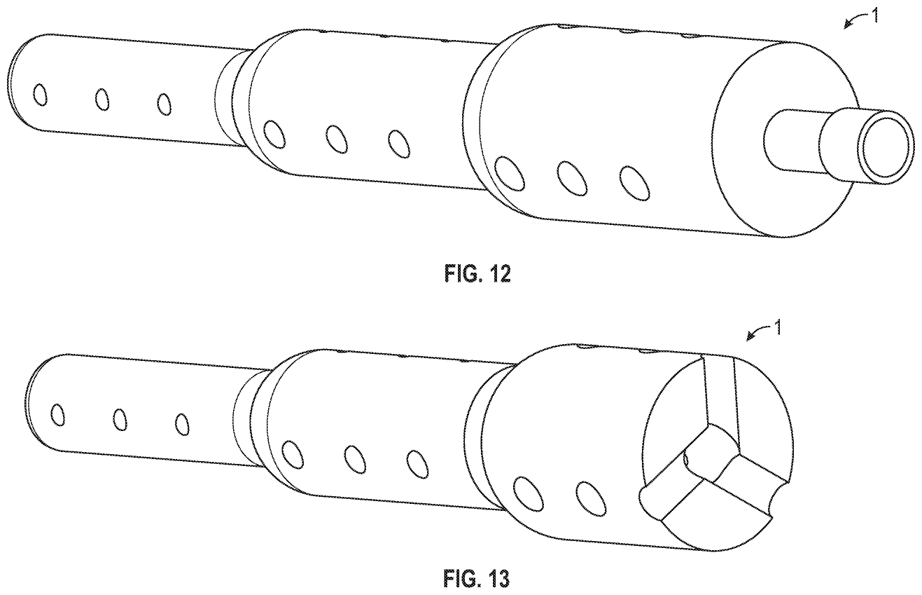

The lower body 19 of the rotor 1 is immersed in the medium in the mixing container 13; the upper body 21 extends beyond the medium. The body is either completely open at the top end and without a cover, or is provided with a cover (see FIG. 12). Alternatively, a cover 11 can close the vessel and the body. The body 1 (also referred to as a mixing element or a rotor) is connected with the shaft of a driving electric motor (not shown) which drives the body 1. The body can be spun by the motor in a clockwise or counterclockwise direction. The body is typically spun in a single direction either clockwise or counterclockwise.

In some embodiments, the lower body has a smaller diameter than the middle body. In some embodiments, the lower body has a smaller diameter than the upper body. In some embodiments, the lower body has a larger diameter than the middle body (not shown). In some embodiments, the lower body has a smaller diameter than the upper body.

In some embodiments, the upper body has a smaller diameter than the middle body (not shown). In some embodiments, the upper body has a smaller diameter than the lower body (not shown). In some embodiments, the upper body has a larger diameter than the middle body. In some embodiments, the upper body has a. larger diameter than the lower body. In some embodiments, the upper body has a larger diameter 2× the diameter of the lower body. In some embodiments, the upper body has a larger diameter 1.5× the diameter of the lower body. In some embodiments, the upper body has a larger diameter, e.g., 1.10-10× the diameter of the lower body.

When the middle and upper body have a larger diameter than the lower body, the liquid volume entering the central cavity 4 will exit from the upper body outflow regions 7a and middle body outflow regions 7b first in comparison to the lower body outflow regions 7c resulting in mixing the entire liquid from bottom to top.

Without being bound to a particular theory, when the distance is far from the center of the circle the force of the movement will be more. Thus, as the diameter across the body increases, the force exerted on the media to push it out the outflow region increases. When the upper body has a larger diameter than the lower body, there is an increase in force in the upper body which causes more media to exit the top outflow regions compared to the bottom outflow regions which in turn causes more lift of media from the bottom of the vessel up causing more mixing. The converse is also true: when the upper body has a smaller diameter than the lower body, there is an increase in force in the lower body which causes more media to exit the bottom outflow regions compared to the top outflow regions (this might be useful in trying to mix a lighter media that is floating on top of a heavier media).

In an embodiment, a lower body is submerged completely under the media and a mid and upper bodies are not submerged. In an embodiment, the lower and mid bodies are submerged completely under the media and the upper body is not submerged. In an embodiment, the lower, mid and upper bodies are submerged completely under the media.

The hollow body can have several profiles. For example, the lower body can have a circular profile (substantially circular in cross-section), and the middle body can have a rectangular or triangular profile (substantially rectangular or triangular in cross-section), and vice versa. In one embodiment, the lower body has a first profile, and the middle body and the upper body have a second profile, wherein the first profile and second profile are different. The first profile can be a circle (substantially circular in cross-section) and the second profile can be a square, tringle or a hexagon. In one embodiment, the lower and mid bodies have a first profile, and the upper body has a second profile, wherein the first profile and second profile are different. The first profile can be a circle (substantially circular in cross-section) and the second profile can be a square, tringle or a hexagon. In one embodiment, the lower, mid and upper bodies all have different profiles. In one embodiment, the lower, mid and upper bodies all have the same profiles (e.g., circular (substantially circular in cross-section), triangular (substantially triangular in cross-section) or a hexagonal (substantially hexagon shaped in cross-section)). These different profiles may result in turbulent, shear force, and some impact inside the hollow body which may not be desirable in some cases and desirable in other cases. The different profiles will also change the fluid dynamics during mixing.

The first media and second media begin mixing in the body cavity 4.

### Inflow Regions

The lower body comprises at least one inflow region, also referred to as an inlet region, inlet opening, inflow unit and the like, such as, e.g., an inflow region 6 as shown in FIG. 4.

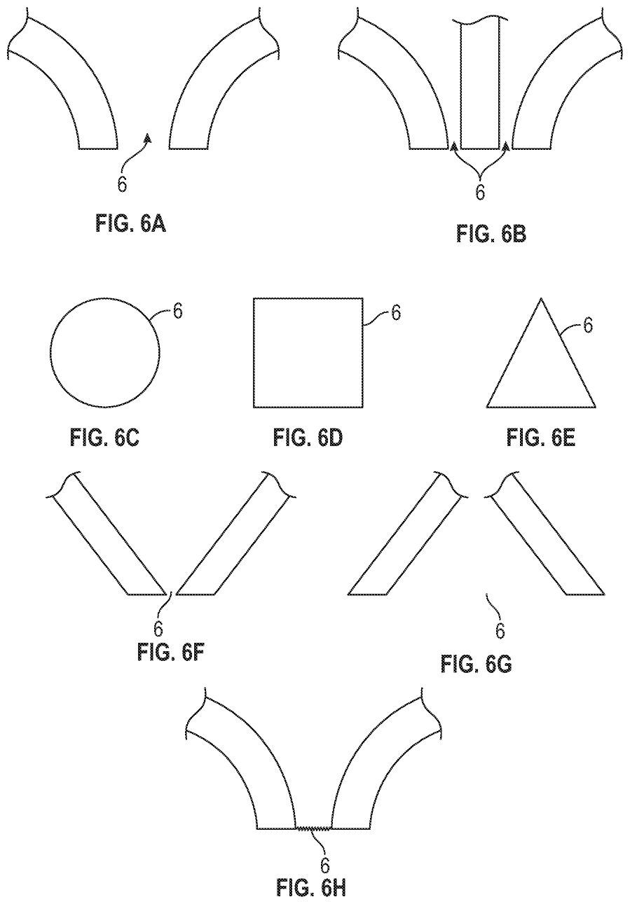

In one embodiment, the inflow region is either one central inlet opening (FIG. 6A) or a number of inlet openings (see, e.g., FIG. 6B). In some embodiments, the inflow regions are disposed symmetrically around the center of the bottom of the body. In some embodiments, the inflow regions are disposed asymmetrically around the center of the bottom of the body.

In one embodiment, the inflow region has a uniform shape, i.e. all inflow regions are cylindrical, square or triangular (FIG. 6C-6E). If the body has multiple inflow regions, the inflow regions can be of various shapes, i.e., some of the inflow regions are cylindrical, square or triangular while other inflow regions are cylindrical, square or triangular.

If the body has multiple inflow regions, all the inflow regions have uniform diameters, i.e. all inflow regions are the same diameter. In one embodiment, the inflow regions can be of various diameters i.e., a first inflow region has a first diameter and a second inflow region has a second diameter wherein the first diameter is smaller than the second diameter. In some embodiments, a first inflow region has a first diameter and a second inflow region has a second diameter wherein the first diameter is different than the second diameter.

In one embodiment, the inflow region has a variable diameter, i.e., the inflow region starts narrower at the outer body and expands towards the inner body (FIG. 6F), or the inflow region starts broader at the outer body and narrows towards the inner body (FIG. 6G).

The openings of the inflow region can be of various shapes and sizes. The location of the inflow opening(s) is at the distal tip of the body.

In one embodiment, as illustrated schematically in FIG. 6H, the inflow region (for regions) has one or more filters, diffusors, nozzles, stream rectifiers, extensions for defoaming or for the foaming of the media, or can be provided with other extensions rectifying the stream, or for varying the amount of fluid allowed to enter the cavity.

### Outflow Regions

The wall of the body comprises at least one outflow region. Outflow regions, also referred to as outlet openings or outflow units or outlet regions and the like, are referred to collectively at 7. As shown in FIG. 4, some outflow regions 7a can be located in the upper body 21, some outflow regions 7b can be located in the middle body 20, and some outflow regions 7c can be located in the lower body 19. An outflow region, such as the outflow region 7a, has an inner extent and an outer extent. Other than their location on the body, outflow regions 7a, 7b and 7c in the upper, middle or lower body can be the same. But, in some embodiments, the outflow regions in the upper, middle or lower body are different, for example, having a different diameter (size), a different shape or different diameters (sizes) and shapes from each other.

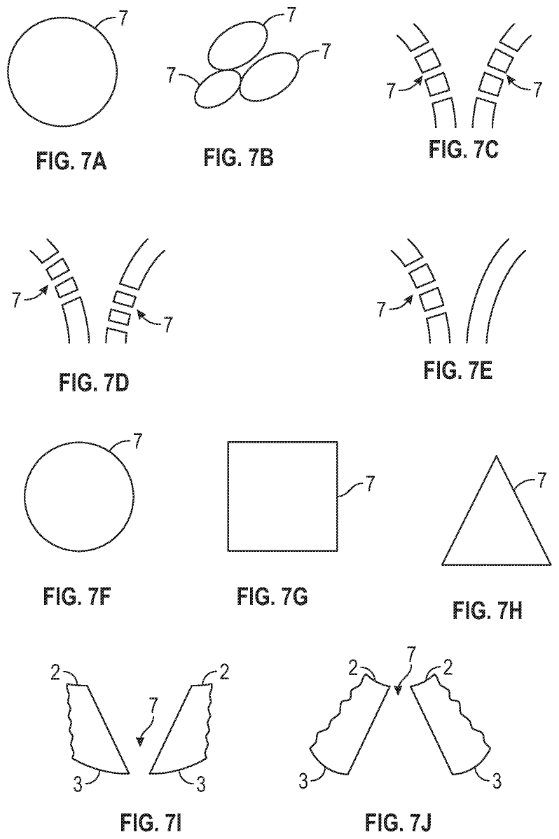

In one embodiment, the outflow region is either one outflow region (FIG. 7A) or a number of outflow regions grouped together (FIG. 7B). In some embodiments, the outflow regions are disposed evenly across the wall of the body (FIG. 7C). In some embodiments, the outflow regions are disposed unevenly across the wall of the body (FIG. 7D). In some embodiments, the outflow re ions are disposed unevenly across only a portion (e.g., one half) of the body (FIG. 7E).

In one embodiment, the outflow regions have a uniform shape, i.e., all outflow regions are cylindrical, square or triangular (FIG. 7F, 7G and 7H). If the body has multiple outflow regions, the outflow regions can be of various shapes, i.e., some of the outflow regions are cylindrical, square or triangular while either outflow regions are cylindrical, square or triangular.

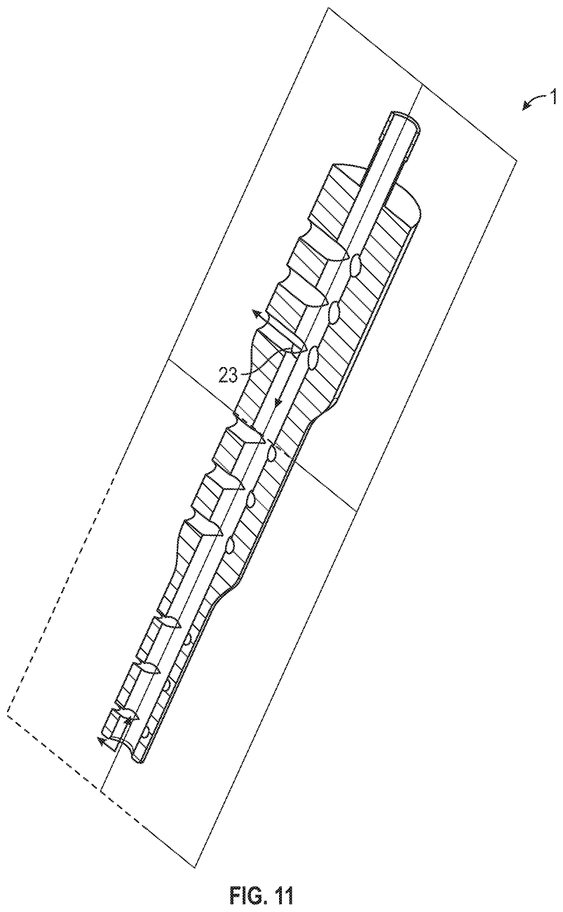

In one embodiment, the outflow regions form a 90 degree angle with the inflow regions. In one embodiment, the outflow regions form a 120 degree angle with the inflow regions. In one embodiment, the outflow regions form a 45 degree angle with the inflow regions. In one embodiment, the outflow regions form between 45-120 degree angle with the inflow regions. In one embodiment, the outflow regions form between 5-175 degree angle with the inflow regions. See, e.g., the acute angle 22 in FIG. 4 compared to the angle 23 (about 90°) in FIG. 11.

If the body has multiple outflow regions, all the outflow regions can have uniform diameters, i.e. all outflow regions are the same diameter. In one embodiment, the outflow regions have various diameters i.e., a first outflow region has a first diameter and a second outflow region has a second diameter wherein the first diameter is smaller than the second diameter. In some embodiments, a first outflow region has a first diameter and a second outflow region has a second diameter wherein the first diameter is different than the second diameter.

In one embodiment, the outflow region has a variable diameter, i.e., the outflow region starts narrower at the outer body and expands towards the inner body or the outflow region starts broader at the outer body and narrows towards the inner body (FIG. 7I and FIG. 7J).

In one embodiment, the openings of the outflow region have various shapes and sizes.

In one embodiment, the outflow region has filters, diffusors, nozzles, stream rectifiers, extensions for defoaming or for the foaming of the media, or can be provided with other extensions rectifying the stream, or for varying the amount of fluid allowed to enter the cavity, similar to that shown for the inflow region in FIG. 6H.

In some embodiments, the outflow regions are disposed symmetrically along the inner/outer wall. In some embodiments, the outflow regions are disposed asymmetrically along the inner/outer wall

In one embodiment, the outflow and inflow regions have various shapes and diameter. In one embodiment, the shape of the outflow and inflow regions vary in different regions of the body. In one embodiment, the diameter of the outflow and inflow regions vary in different regions of the body.

The inflow unit is below the outflow region. The outflow region is above the inflow region.

Without being bound to a particular theory, the disclosed mechanical mixing device operates to a certain extent like a pump such as a centrifugal pump.

In an embodiment, the body is submerged. completely under the media. In an embodiment, the body is partially submerged under the media.

In an embodiment a first outflow region is submerged completely under the media and a second outflow region is not submerged. In an embodiment, a first and second outflow region is submerged completely under the media and a third outflow region is not submerged. In an embodiment, a first second and third outflow region is submerged completely under the media. Stated another way the hollow body is either immersed completely in the medium, or the hollow body is only partially immersed, i.e. a part of the hollow body protrudes above the media's surface.

When the body is rotated, a central vortex is generated in the container. The medium is sucked up into the cavity of the body via the inflow region.

The medium is moved inside the cavity upwards and outwards. Outside the cavity (in the vessel), the medium is moved in multiple directions, upwards and downwards and outwards.

The mixer homogenizes and simultaneously pumps medium and/or particles upwards. The mixer homogenizes and simultaneously pumps particles upwards.

Other mixing effects can arise if the cross section of the hollow body is not circular, but is square, ellipsoidal, or triangular.

Other mixing effects can arise if the outer wall 2 is not smooth i.e., includes a baffle or stirrer.

Other mixing effects can arise if the inner wall 3 is not smooth i.e., includes a baffle or stirrer.

The mixed media (first media and second media mixed) flows out the outlet region.

In some embodiments, the body comprises a lower body, middle body and top body but outflow regions are only located in the top body. In some embodiments, the body comprises a lower body, middle body and top body but outflow regions are only located in the top and mid body. In some embodiments, the body comprises a lower body, middle body and top body and outflow regions are located in the top body, middle body and lower body.

### Outer Wall

In some embodiments, the outer walls of the body (FIG. 4 at 2) of the body are completely smooth. In some embodiments, the outer walls of the body of the body are roughened, provided with extensions, grooves, strips, and the like. In some embodiments, the outer walls of the body have protrusions such as baffles, propellers or paddles to enhance mixing.

### Inner

In some embodiments, the internal walls of the body (FIG. 4 at 3) of the body are completely smooth. In some embodiments, the internal walls of the body of the body are roughened, provided with extensions, grooves, strips and the like. In some embodiments, the inner walls of the body have protrusions such as baffles, propellers or paddles to enhance mixing.

### Cavity

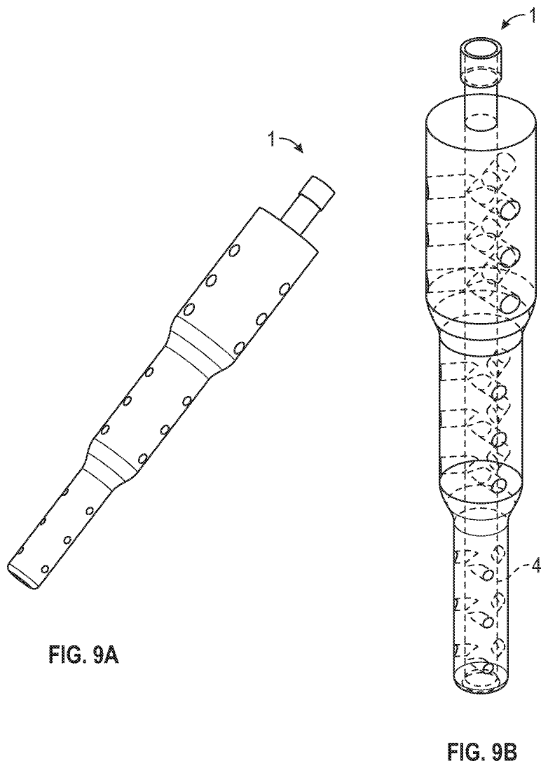

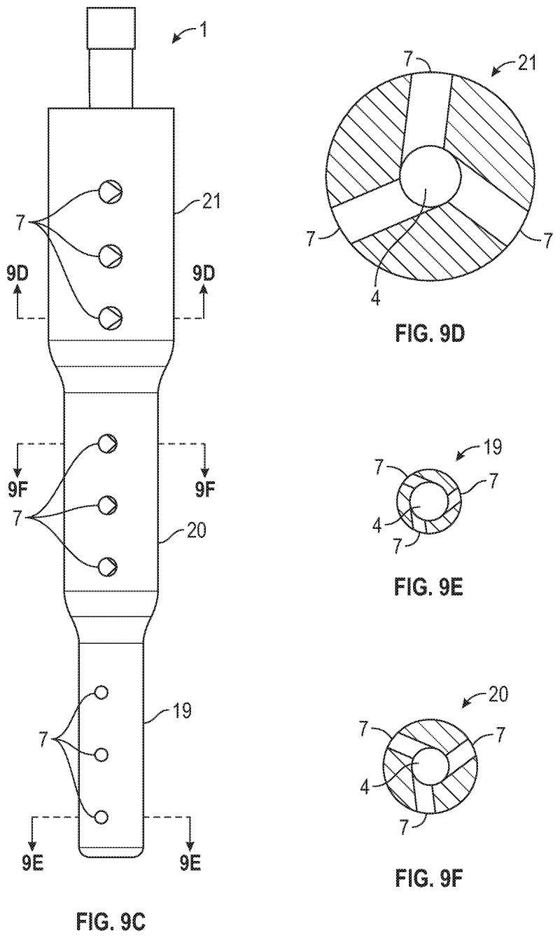

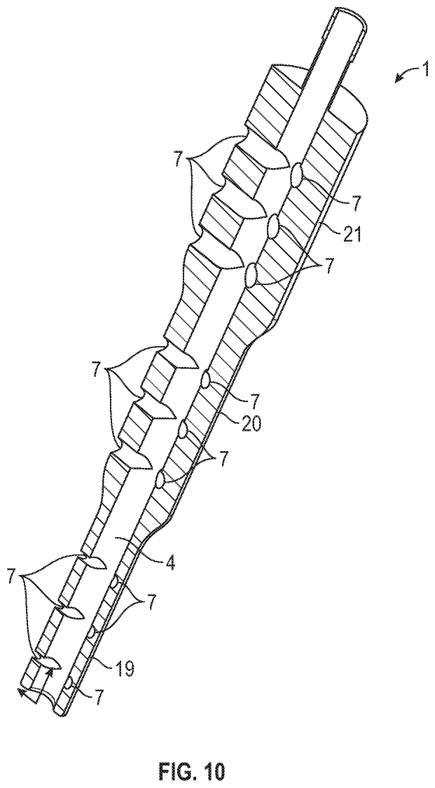

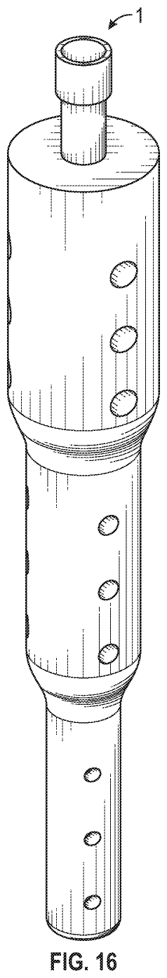

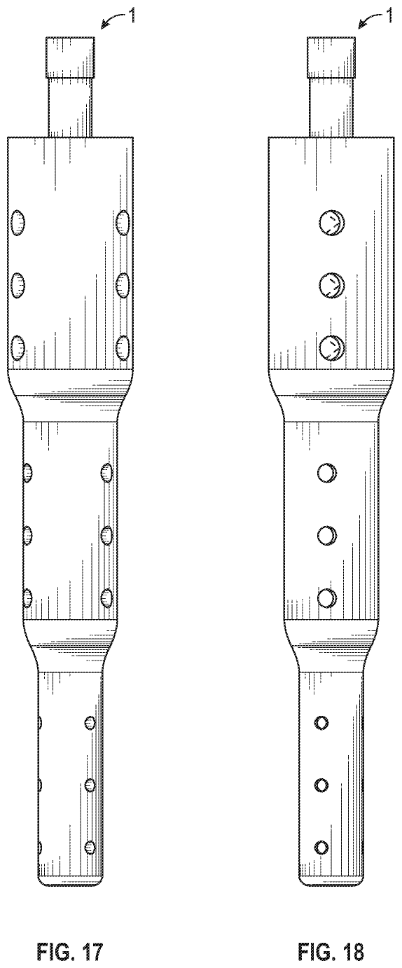

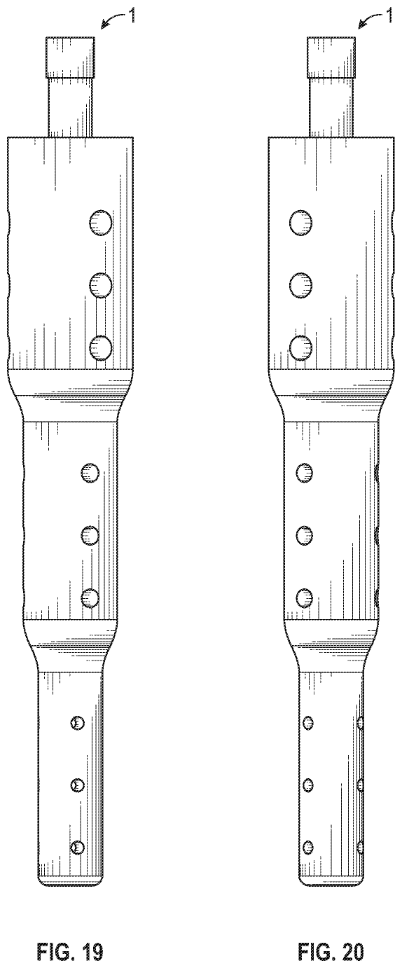

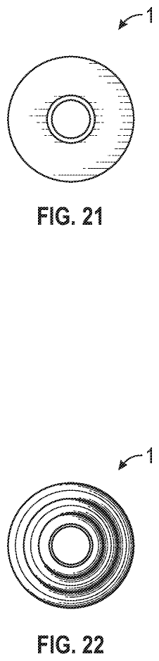

The cavity 4 is also referred to as the centrifuge chamber. In some embodiments, at a first time point the cavity comprises a first media and not a second media. In some embodiments, at a first time point the cavity comprises a first media and a second media. In some embodiments, at a second time point the cavity comprises a first media and a second media. Mixing begins in the cavity. The diameter of the cavity determines the amount of lift, created by the central vortex. The cavity 4 can have different cross sectional areas (e.g., diameters) along its length from a distal end adjacent the inflow openings) 6 to a proximal end of the body 1 (see, e.g., FIG. or a constant cross sectional area (see, e.g., FIGS. 9A-22). In some embodiments, where the cavity 4 is constant, the wall 5 is thicker at the upper body compared to the lower body so that the top portion has a larger diameter than the middle portion, and the middle portion has a larger diameter than the lower portion. In some embodiments, where the cavity 4 has different cross-sectional areas, the wall 5 is constant at the upper body compared to the lower body but the top portion still has a larger diameter than the middle portion, the middle portion still has a larger diameter than the lower portion.

### Dispersion Characteristics

The media dispersion characteristics (fan shaped, crosswise, of the shape of a rising helix, etc.) can be changed by the shape and location of outflow regions.

The speed and amount of liquid leaving the body through the outflow regions depends on the speed of rotation of the body, on the diameter and height of the body, on the diameter of the outlet regions, and furthermore on the distance of the inflow regions or of the inflow region from the level of the medium, the distance between the inflow and outflow regions, the angle between the center of the outflow and center of inflow region, the viscosity of the medium. The speed and amount of liquid leaving the body through the outflow regions can be determined by a skilled artisan.

Mixing can be influenced by the speed of the body, by its size, by the diameter of inflow and outflow regions, and by the degree of immersion of the body below the level of the first medium and/or second medium.

The disclosed embodiments permit improved recirculation of the medium in the container without regard to its viscosity (even with highly viscous liquids).

### Rotor/Body

The drive of the body can be provided from below or from the top.

The body has a function similar to that of an impeller, i.e. its task is to transmit kinetic energy to the medium.

### Container/Vessel

The shape of the vessel or container can be optional (rotation cone, cylinder, polyhedron and the like).

In the specific example of FIG. 4, the container 13 has a lower portion 14, a mid-portion 15 and an upper portion 16.

The container 13 has two working spaces: outside the body 1 and an interior 4 of the body 4. Prior to rotation of the body 1, which is partly immersed in the medium, the medium enters through the central opening 6 in the bottom into the body 1 and through the outlet openings 7.

During rotation of the body 1, which is partly immersed in the medium, the medium enters through the central opening 6 in the bottom into the body 1. The liquid medium rises in the body 1 due to centrifugal forces and is dissipated through outflow regions 7 back into the container 13.

In some embodiments, an upper portion of the body is free to rotate relative to a stationary lower part of the body. In some embodiments, a lower portion of the body is free to rotate relative to a stationary upper part of the body.

In one embodiment, the container is not heated, rotated or rocked. In one embodiment, the container is not heated. In one embodiment, the container is not rotated. In one embodiment, the container is not rocked. In one embodiment, the container is heated, rotated and/or rocked. In one embodiment, the container is heated. In one embodiment, the container is rotated. In one embodiment, the container is rocked.

Mixing can be measured by a sensor in the vessel, in the cavity or both.

### Axis of Rotation

The axis of rotation of the body is optional (i.e., it can be verticle, inclined, horizontal depending upon desired results and operating requirements).

### Medium Movement

The medium, for instance liquid, enters the body through the inflow region. The medium exits the body at a height that corresponds to the height of the medium. The medium exits the body out the outflow region.

Before the body is rotated, when the body is in the medium, the level of the medium is substantially the same inside and outside the body. In some embodiments, the height of the medium inside the body before rotation may be slightly higher due to capillary actions. While the body is being rotated, the level of the medium is substantially the same inside and outside the body. In some embodiments, the height of the medium inside the body during rotation may be slightly higher due to capillary actions. After the body is rotated, the level of the medium is substantially the same inside and outside the body. In some embodiments, the height of the medium inside the body after rotation may be slightly higher due to capillary actions.

When the body is being rotated, medium within the outflow region (defined by the distance between 8 and 9 referred to as the outflow tube) will be pushed out of the outflow tube which creates a lifting energy to move the liquid within the central cavity upwards to create a central rising vortex. The vortex raises the medium from the bottom of the vessel into the cavity, up the inner wall and out an outflow region. Without being bound to a single theory, due to large centrifugal forces, particularly no (or minimal) losses are experienced in this vortex and no (or minimal) interfering hydrodynamic movements due to turbulence, friction against the walls, unproductive whirling and the like are also not present. It is a natural movement. The central vortex is symmetrical but mixing is achieved in all areas of the vessel and samples can be removed from the upper part of the vessel, mid part of the vessel or lower part of the vessel. The central vortex Is symmetrical but mixing is achieved in all areas of the vessel and samples can be removed from the upper part of the body cavity, mid part of the body cavity or lower part of the body cavity.

The fluid is sucked into the body 1 via the inflow opening 6. The fluid in the cavity 4 is raised by centrifugal force along the inner walls 3 of the body 1 in the form of a rising spiral and is discharged either over the rim 12 of the body 1, or through outflow regions 7 in the body 1. Only outflow regions 7 below the level or at the level of the medium contribute to mixing of the medium, as they enable the ejection of the medium out of the cavity 4.

The mixing system mixes the medium without the use of pumps.

### Vertical Baffles

Optionally, one or more baffles 17 and 18 can be arranged in the mixing container 13. The baffles are arranged below the level of the medium. In some embodiments, they are arranged in a longitudinal direction similar to the body.

### Paddles

In some embodiments, paddles (not shown) are provided on the outer wall of the body for the generation of local vortexes and turbulences.

### Mixing

Without being hound to a single theory, the hollow body forms two working spaces: (1) the interior 10 of the mixing container 13 (i.e., exteriorly of the body) and (2) the cavity 4 (i.e., interiorly of the body).

The fluid is mixed outside the body 1 due to friction of the external walls 2 of the body 1 with the fluid within the mixing container 13.

If the cross section of the body 1 has the shape of a rectangle, a triangle, a square, an ellipse or the like, then the edges, and overall shape of the body 1, cause a further mixing effect below the level of the media which is similar, for instance, to that of mixing devices with blades.

The system works with volumes of a few hundred microliters (100-1000) or a large-scale bioreactor with a volume of a few hundred liters (1-1000).

### RPM

The agitation speed (rpm) of the body can be controlled by a potentiometer (not shown) that changes the voltage to a motor (not shown). In some cases, the agitation speed can be selected by visually observing the agitation dynamics (flow pattern) in vessel.

### Types of Media

Disclosed is a method for uniformly mixing heterogeneous or multiphase systems. Disclosed is a method for uniformly mixing a liquid and a media that has settled in the bottom of the vessel or container.

The mixing device can be used with all kinds of media, namely low viscous media, high viscous media, and also those which in the course of mixing change their viscosity or form a suspension, newtonian and non-newtonian liquids, or media containing a solid, for instance fibrous particles and the like. The mixing device can be used with all kinds of media, including liquids, gases, solids and combinations thereof. The mixing device can be used with all kinds of media, including gases, namely air, helium, hydrogen, nitrogen and combinations thereof. The mixing device can be used for the fermentation of microorganisms. The mixing device can be used with all kinds of media, including liquids, namely water, blood, urine, gasoline, mercury (an element), bromine (an element), wine etc. The mixing device can be used with all kinds of media, including solids, namely bacteria, beads, resin, algae, rubber, latex etc.

At least one media can be introduced into the vessel via at least one port. A first media can be introduced into the vessel via a first port and a second media can be introduced into the vessel via a second port.

In one embodiment, there is a system for delivering, and mixing fluids, comprising: a first fluid source configured to supply a first fluid, at least a second fluid source configured to supply at least a second fluid; a first fluid line configured for fluid connection with the a first fluid source for supplying the first fluid; at least a second fluid line in configured for fluid connection with the at least second fluid source for supplying at least the second fluid; a mixer for mixing the first media and second media components together by rotating a body to form a centrifugal force inside a cavity of the body wherein the first input port is in fluid communication with the first fluid line, the at least second input port is in fluid communication with the at least second fluid line, and the outlet port is in fluid communication with an the inlet of the pump.

In one embodiment, there is a system for delivering, mixing and extracting fluids, comprising: a first fluid source configured to supply a first fluid; at least a second fluid source configured to supply at least a second fluid; a first fluid line in configured for fluid connection with the a first fluid source for supplying a first fluid; at least a second fluid line in configured for fluid connection with the at least second fluid source for supplying at least a second fluid; a mixer for mixing the first media and second media components together by rotating a body to form a centrifugal force inside a cavity of the body wherein the first input port is in fluid communication with the first fluid line, the at least second input port is in fluid communication with the at least second fluid line.

In one embodiment, there is a system for delivering, mixing and extracting fluids, comprising: a first fluid source configured to supply a first fluid; at least a second fluid source configured to supply at least a second fluid; a first fluid line in configured for fluid connection with the a first fluid source for supplying a first fluid; at least a second fluid line in configured for fluid connection with the an at least second fluid source for supplying at least a second fluid; an outlet port; a mixer for mixing the first media and second media components together by rotating a rotor to form a centrifugal force inside a cavity of the rotor wherein the first input port is in fluid communication with the first fluid line, the at least second input port is in fluid communication with the at least second fluid line, and the outlet port is in fluid communication with a fluid depository vessel.

### Operation

The device can operate under any conditions, for instance, at different temperatures, pressures or in a vacuum, in an electric, magnetic or other power field, and so forth.

The mixing device can be used in all forms and methods of technical material processing including the adhesives, chemical, biological, pharmaceutical, fermentation, agricultural, petrochemical, cosmetics, food, electronics, plastics, automotive, energy, petroleum, pharmaceutical, chemical industries, other manufacturing, medical and other fields, and other endeavors. Mixing devices can be used for emulsification, homogenization, dispersion, energize, chemically bind, and mix liquids and suspensions to facilitate cellular or molecular interactions.

The mixer can be used for different applications as well as different processes, such as but not limited to bacteria and cell culture and dispensing, mixing during 3D bioprinting, mixing bioassay samples with coated magnetic beads, microfluid mixing, etc. The mixer can be used for mixing biological components. A biological component is any component having a biological origin. Biological components include cells, nucleic acids, enzymes, buffers, proteins and dyes. Cells include blood, bone marrow, umbilical cord or digested tissue such as growth factors, cytokines, proteins or cell groups. The mixer can be used for mixing biochemical compounds such as carbohydrates, proteins, lipids (fats), and nucleic acids.

The speed of mixing is controlled by the rotary motion (RPM) of the body.

In some embodiments, a third media is added to the vessel as the body is mixing a first media and a second media.

In some embodiments, two or more media are mixed by the system.

### Manufacture

The device is of simple construction and its manufacture is not complex. The body can be made of various material including plastics, metals, rubber etc.

Mass production could be, for instance, carried out by any suitable known forming technique, including injection molding of molding of plastics and other known techniques appropriate for the body material.

### Method

Without being bound to a single theory, as the body spins liquid inside the cavity flows out through an outflow region which creates lift inside the cavity. The liquid inside the cavity uses this lift to take in more fluid from the inflow region and pushing it out through the outflow regions. The result is a continuous movement of the liquid and mixing of the media. Heavier items (such as particles, or liquids) are moved up. Lighter items (such as particles, or liquids) are moved down. The media is mixed. The mixer allows for a complete mixture of particles in a liquid without mechanically damaging them. The mixer allows for a complete mixing of one liquid with a second liquid without mechanically damaging either liquid. The mixer allows for a complete mixture of one gas with a liquid without mechanically damaging either the liquid or gas particles. Without being bound to a single theory, mixing occurs without damage because no propellers are used in this design and all the surfaces and transitions are smooth.

### Sample Analysis

The system can also be used for sample analysis. As the first media and second media are being mixed, a mixed sample can be drawn from the vessel (FIG. 4 at 10), or it can be drawn from the cavity (FIG. 4 at 4), or it can be drawn from both, and then the mixed sample is analyzed. Data can then be collected from the mixed sample. A result can be determined based on the collected data.

### Suction

The device and method can be used for creating vacuums and suction. For example, if the device were rotated in air, it would create suction from the bottom of the cavity toward the top of the cavity. In some embodiments, a dust bin (not shown) is joined outside the outflow regions or to the bottom end of the body in order to collect the dust or dirt lifted by the suction. Stated another way, the dust bin can be installed in such a manner that a longitudinal axis thereof is substantially parallel to the longitudinal axis of the body.

### Device to Generate Rotation

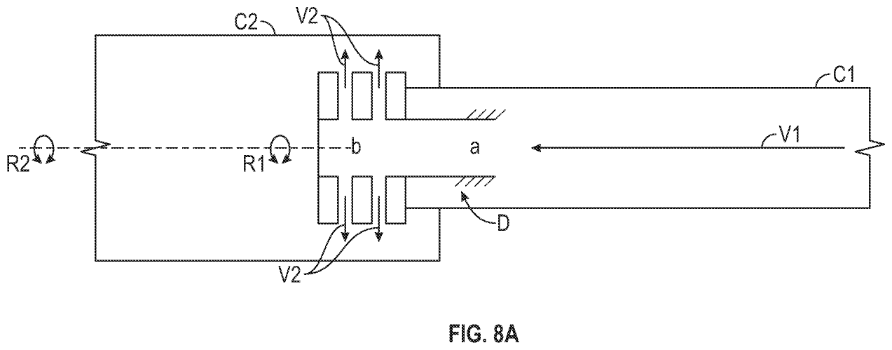

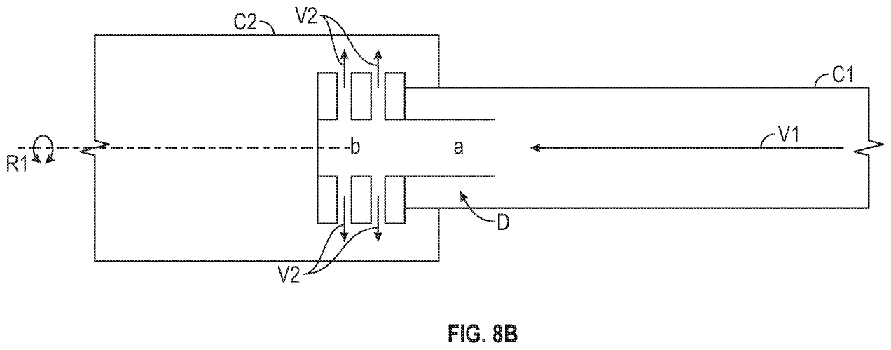

The device can also be used to create rotation. Referring to FIG. 8A, fluid can be caused to flow from a first container (C1) into a cavity (b) of a device (D) at a first velocity (V1) and out of the cavity b at a second velocity (V2) into a second surrounding container (or housing)(C2). The device D in FIG. 8A can also be oriented vertically. The fluid flow causes the device D to rotate at a first rotation (R1). As the fluid flows out the cavity b at V2, the velocity of the fluid can be used to rotate the second container C2 at a second rotation (R2). The rotation of the second container C2 can be used to create, for example, electricity. In this embodiment, the device D may have a first portion (a) which does not rotate, and a second portion, which includes the cavity (b), that is free to rotate. In an alternate embodiment, the device may have a first portion (a) which rotates, and a second portion, which includes the cavity (b), that also rotates.

### Device to Dampen Velocity of a Moving Fluid

The device can also be used to dampen the rate of media movement. Fluid flows from a first container (C1) into the device cavity b at a first velocity (V1) and out of the cavity b at a second velocity (V2) into a second container (C2), as shown in FIG. 8B. As the fluid flows out the cavity at V2, the velocity V2 is slower than V1. In this embodiment, the device D is not connected to a motor but is free to rotate. In this configuration, the top of the device D is closed. As the fluid is pushed through the device D, and out the outflow regions, the body will start rotating, slowing the flow of water from the first container C1 to the second container C2.

### Numbered Paragraphs

The mixer can be understood by the following numbered paragraphs:

Paragraph 1: A device for the mixing media the device comprising a body, the body comprising at least a first inlet opening, a hollow cavity and a wall, the wall comprising at least a first outflow region.

Paragraph 2: A method of mixing a media wherein the media is stored in a vessel with a mixer, the mixer comprising a body, the body comprising at least a first inlet opening, a body cavity and a wall, the wall comprising at least a first outflow region wherein when the mixer is rotated media enters the body cavity by the inlet opening and exists the body cavity via the outflow region.

Paragraph 3: A mixing device for mixing at least one first ingredient and at least one second ingredient in a vessel, the device comprising: a body having at least one wall defining a cavity; the body having at least one first inlet communicating with the vessel and the cavity wherein the at least one first ingredient and at least one second ingredient are introduced into the cavity via the at least one first inlet; and at least one outlet communicating with the cavity and the vessel for receiving the mixture of the first ingredient and second ingredient mixed in the cavity wherein the mixture is expelled from the cavity to the vessel via the at least one outlet.

Paragraph 3.1: The mixing device of Paragraph 3 wherein before mixing, the at least one first ingredient is located only in the bottom section of the vessel and the wherein the at least one second ingredient is located in the bottom section, midsection and top section of the vessel.

Paragraph 4. An apparatus for mixing at least a first and second fluid in a vessel, the vessel comprising a first portion and a second portion, comprising: (a) a cavity having a first portion and a second portion; (b) a first opening comprising a first flow duct connecting the first portion of the cavity and the first portion of the vessel; and (c) a second opening comprising a second flow duct connecting the second portion of the cavity and the second portion of the vessel.

Paragraph 4.1: The apparatus of Paragraph 4 wherein, the cavity's first is below the second portion and the vessel's first portion is below a second portion.

Paragraph 5. A method for mixing a first media with a second media, the method comprising: advancing the first media from a vessel into a rotor cavity; advancing the first media from a first portion of the rotor cavity up to a second portion of the body cavity; advancing the first media from out the second portion of the rotor cavity.

Paragraph 6. A method for mixing a first media with a second media, the method comprising: mixing the first media and second media components together by rotating a rotor to form a centrifugal force inside the cavity of the rotor.

Paragraph 7. A method for preparing an assay cartridge, the method comprising: mixing first media and second media components together by rotating a rotor to form a centrifugal force inside the cavity of the rotor to form a mixed media; inserting a draw device into the vessel; drawing mixed media out of the vessel; dispensing the mixed media onto an assay cartridge.

Paragraph 7.1: The apparatus of Paragraph 7 wherein, the draw device is a needle, pipet, or suction.

Paragraph 7.2: The apparatus of Paragraph 7 wherein, the draw device is in fluid communication with an outlet.

Paragraph 8. A mixing apparatus, comprising: (a) a top portion, a mid portion and a lower portion wherein the top portion has a larger diameter than the mid portion, the mid portion has a larger diameter than the lower portion; (b) a plurality of outflow channels which extend axially through the mixing apparatus; (c) at least one inflow channel; and (d) a cavity.

Paragraph 9. A mixing de vice for mixing at least one first ingredient and at least one second ingredient, the device comprising: a body having at least one wall defining a cavity; a chamber being defined in the cavity; at least one first inlet communicating with the chamber of the cavity for introducing at least one first ingredient into the chamber of the cavity; at least one outlet for communicating with the chamber of the cavity for expelling at least one first ingredient out the chamber of the cavity.

Paragraph 9.1: The apparatus of Paragraph 9 wherein, when the mixing device is not moving the second opening communicates with the chamber of the cavity for introducing at least one first ingredient into the chamber of the cavity.

Paragraph 9.2: The apparatus of Paragraph 9 wherein, when the mixing device is moving the at least one first inlet introduces at least one second ingredient into the chamber of the cavity and wherein the at least one outlet expels at least one second ingredient out the chamber of the cavity.

Paragraph 9.3: The apparatus of Paragraph 9 wherein, the at least one first inlet and the at least one outlet initially allow flow into the cavity of the chamber.

Paragraph 9.4: The apparatus of Paragraph 9 wherein, when the mixing device is mixing the at least one first inlet allows flow into the cavity of the chamber and the and the at least one outlet allows flow out the cavity.

Paragraph 9.5: The apparatus of Paragraph 9 wherein, when the at least one first inlet is below the at least one outlet.

Paragraph 10: A method for mixing at least one first ingredient and at least one second ingredient, the method comprising:

receiving at least one first ingredient and at least one second ingredient in a vessel with a mixing body disposed within the vessel; and

mixing the at least one first ingredient and the at least one second ingredient by spinning the mixing body, wherein the mixing body comprises at least one inlet, at least one outlet and a cavity, and wherein in response to spinning the mixing body, the at least one first ingredient and the at least one second ingredient enter the cavity via the at least one inlet, and exit the cavity via the at least one outlet thereby mixing the at least one first ingredient and the at least one second ingredient.

Paragraph 10.1. The method according to Paragraph 10, wherein the at least one inlet has a filter.

Paragraph 10.2 The method according to Paragraph 10, wherein the at least one second ingredient is dispersed higher in the vessel when the body has a first portion having a first diameter and a second portion having a second diameter and the diameter of the second diameter is greater than the first diameter.

Paragraph 10.3 The method according to Paragraph 10, wherein in response to spinning the mixing body a vortex is created in the body.

Paragraph 10.4 The method according to Paragraph 10, wherein prior to mixing, in step a, the at least one first ingredient and at least one second ingredient have a first height and wherein during the mixing step in step b, the at least one first ingredient and at least one second ingredient also have a first height.

Paragraph 10.5 The method according to Paragraph 10, wherein prior to mixing, in step a, the at least one first ingredient is in the cavity, in the at least one inlet, and in the at least one outlet and the at least one second ingredient is in the at least one inlet and not in the cavity or in the at least one outlet.

Paragraph 10.6 The method according to Paragraph 10, wherein during the mixing step, step b, the at least one first ingredient is in the cavity, in the at least one inlet, and in the at least one outlet and the at least one second ingredient is in the cavity, in the at least one inlet, and in the at least one outlet.

Paragraph 10.7 The method according to Paragraph 10, further comprising removing a sample of the mixed at least one first ingredient and at least one second ingredient from the vessel.

Paragraph 11 A mixing device for mixing at least one first ingredient and at least one second ingredient, the device comprising: a rotatable body, the body comprising at least a first portion and at least a second portion and at least one wall defining a cavity; the at least one first portion having at least one first inlet communicating with the cavity for introducing at least one first ingredient into the cavity; the at least one second portion comprising at least one outlet for communicating with the cavity for expelling at least one first ingredient out the cavity.

Paragraph 11.1 The mixing device of Paragraph 11, wherein the diameter of the first portion is less than the diameter of the second portion.

Paragraph 11.2 The mixing device of Paragraph 11, wherein the at least one first ingredient is in the at least one first inlet and the at least one outlet and the at least one second ingredient is in the at least one first inlet and not in the at least one outlet.

Paragraph 11.3 The mixing device of Paragraph 11, wherein the at least one second ingredient is in the at least one first inlet and the at least one outlet.

Paragraph 11.4 The mixing device of Paragraph 11, wherein the at least one second ingredient is more dense, heavier, more viscous and combinations thereof than the at least one first ingredient.

Paragraph 11.5 The mixing device of Paragraph 11, wherein the at least one first ingredient does not change.

Paragraph 11.6 The mixing device of Paragraph 11, wherein at a first time point the at least one second ingredient is at a first level and at a second time point the at least one second ingredient is at a second level wherein the second level is higher than the first level.

Paragraph 12. A mixing device for mixing at least one first ingredient and at least one second ingredient, the device comprising: a rotatable body, the body comprising at least a first portion having a first diameter and at least a second portion having a second diameter and at least one wall defining a cavity; the at least one first portion having at least one first inlet communicating with the cavity for introducing at least one first ingredient into the cavity; the at least one second portion comprising at least one outlet for communicating with the cavity for expelling at least one first ingredient out the cavity wherein the second diameter is greater than the first diameter.

Paragraph 12.1 The mixing device of Paragraph 12, wherein the first portion further comprises at least one outlet for communicating with the cavity.

Paragraph 12.2 The mixing device of Paragraph 12, wherein the cavity further comprises baffles.

Paragraph 12.3 The mixing device of Paragraph 12, wherein the body comprises a lid.

Paragraph 12.4 The mixing device of Paragraph 12, wherein the at least one first ingredient and a at least one second ingredient are inside the cavity.

Paragraph 12.5 The mixing device of Paragraph 12, wherein the at least one outlet is positioned at about a 5-175o angle with the at least one inlet.

Paragraph 12.6 The mixing device of claim Paragraph 12, wherein the mixing device is formed as a single piece.

1. A method for mixing biological components, the method comprising:
a. receiving at least one first ingredient and at least one second ingredient in a vessel with a mixing body disposed within the vessel; and
b. mixing the at least one first ingredient and the at least one second ingredient by spinning the mixing body, wherein the mixing body comprises at least one inlet, at least one outlet and a cavity, and wherein in response to spinning the mixing body, the at least one first ingredient and the at least one second ingredient enter the cavity via the at least one inlet, and exit the cavity via the at least one outlet thereby mixing the at least one first ingredient and the at least one second ingredient.

2. The method according to claim 1, wherein the at least one inlet has a filter.

3. The method according to claim 1, wherein the at least one second ingredient is dispersed higher in the vessel when the body has a first portion having a first diameter and a second portion having a second diameter and the diameter of the second diameter is greater than the first diameter.

4. The method according to claim 1, wherein in response to spinning the mixing body a vortex is created in the body.

5. The method according to claim 1, wherein prior to mixing, in step a, the at least one first ingredient and at least one second ingredient have a first height and wherein during the mixing step in step b, the at least one first ingredient and at least one second ingredient also have a first height.

6. The method according to claim 1, wherein prior to mixing, in step a, the at least one first ingredient is in the cavity, in the at least one inlet, and in the at least one outlet and the at east one second ingredient is the at least one inlet and not in the cavity or in the at least one outlet.

7. The method according to claim 1, wherein during the mixing step, step b, the at least one first ingredient is in the cavity, in the at least one inlet, and in the at least one outlet and the at least one second ingredient is in the cavity, in the at least one inlet, and in the at least one outlet.

8. The method according to claim 1, further comprising removing a sample of the mixed at least one first ingredient and at least one second ingredient from the vessel.

9. A mixing device for mixing biological components, comprising:
a rotatable body, the body comprising at least one first portion and at least one second portion adjacent the first portion, wherein the second portion has a circumference greater than the first portion, the body having at least one wall defining a cavity;
the at least one first portion having an end with an inlet opening coaxial with an axis of rotation for the rotatable body and communicating with the cavity for introducing at least one first ingredient into the cavity;
the at least one first portion having an array of spaced-apart first peripheral openings that communicate with the cavity;
the at least one second portion having an array of spaced-apart second peripheral openings that communicate with the cavity,
wherein the rotatable body is configured during rotation while at least partially submerged to draw in the at least one first ingredient through the inlet opening and into the cavity, creating a flow through the cavity and out through the first and second peripheral openings.

10. (canceled)

11. The mixing device of claim 9, wherein the inlet opening is configured to receive the at least one first ingredient and at least one second ingredient into the cavity, and the first and second peripheral openings are configured to expel a mixture of the at least one first ingredient and the at least one second ingredient from the cavity.

12. (canceled)

13. The mixing device of claim 11, wherein the at least one second ingredient is more dense, heavier, more viscous and combinations thereof than the at least one first ingredient.

14. The mixing device of claim 9, wherein the at least one first ingredient does not change.

15. The mixing device of claim 11, wherein at a first time point the at least one second ingredient is at a first level and at a second time point the at least one second ingredient is at a second level, wherein the second level is higher than the first level.

16. A mixing device for mixing biological components, comprising:
a rotatable body, the body comprising at least a first portion having a first diameter, at least a second portion having a second diameter and at least one wall defining a cavity, wherein the second portion is adjacent the first portion and the second diameter is greater than the first diameter;
the at least one first portion having at least one inlet communicating with e cavity; and
the at least one second portion comprising spaced-apart peripheral openings and respective non-radial passages that communicate with the cavity,
wherein the rotatable body is configured to be positioned with at least the inlet submerged in liquid and caused to rotate, thereby drawing the liquid through the inlet and into the cavity, and expelling the liquid from the cavity through the non-radial passages and the peripheral openings.

17. The mixing device of claim 16, wherein the first portion further comprises at least one outlet for communicating with the cavity.

18. The mixing device of claim 16, wherein the cavity further comprises baffles.

19. The mixing device of claim 16, wherein the body comprises a lid.

20. (canceled)

21. The mixing device of claim 16, wherein the at least one outlet is positioned at about a 5-175° angle with the at least one inlet.

22. The mixing device of claim 16, wherein the mixing device is formed as a single piece.

23. The mixing device of claim 9, wherein the first peripheral openings and the second peripheral openings are aligned with each other in a longitudinal direction.

24. The mixing device of claim 9, wherein the first peripheral openings comprise three peripheral openings that are equally spaced from each other in a circumferential direction.

25. The mixing device of claim 9, wherein the second peripheral openings comprise three peripheral openings that are equally spaced from each other in a circumferential direction.
